(19) United States
(12) Patent Application Publication
(10) Pub. No.: US 2018/0370001 A1
(43) Pub. Date: Dec. 27, 2018

(54) END CAP REMOVER

(71) Applicant: Web Industries, Inc., Marlborough, MA (US)

(72) Inventor: Frederick R. Bills, Auburn, GA (US)

(73) Assignee: Web Industries, Inc., Marlborough, MA (US)

(21) Appl. No.: 15/629,627

(22) Filed: Jun. 21, 2017

(51) Int. Cl. B25B 27/02; B25G 1/10

(52) U.S. Cl. CPC B25B 27/02; B23P 19/025; B25G 1/102

(57) ABSTRACT

A tool for extracting plugs or end caps.

### FIELD OF THE INVENTION

The present invention pertains to a tool for removing plugs or end caps having a hole, especially a centrally located hole. In particular, the present invention is directed to a tool for removing plugs or end caps from winding cores.

### BACKGROUND OF THE INVENTION

A number of industries employ caps or plugs to assist in the processing of materials which caps or plugs are to be removed once the processing step is completed. This is particularly so in the winding industry where a stock material, commercial material, consumer material, etc. is wound on a core, spool, spindle or the like, altogether hereinafter “core elements.” Exemplary wound materials include paper, fabrics, tapes, textiles, cables, ropes, wires, composite materials, fibers, and the like, altogether “wound materials.” The winding and unwinding processes involve loading a core element onto an axel or an apparatus having chucks or like elements which engage the core elements and allow for the rotation of the core elements, either a free rotation or a rotation driven by or assisted by a motor associated with the axel or chucks.

Depending upon the nature and properties of the wound material as well as the size of the windings to be completed, the core elements will be of varying diameters. Specifically, if the wound material is a stiffer material or one prone to stretching without recovery, it is oftentimes necessary to use core elements of a relatively large diameter so that arc of the initial windings is less stenuous on the materials being wound. A larger diameter core element may also be needed if the materials being wound are heavy and/or the windings are to be quite large so as to bear the weight of the wound materials.

In order to address the multitude of different diameter core elements, manufacturers of winding apparatus would have to continually customize equipment, which is not always possible given the structure and alignment of the elements of the apparatus. Furthermore, while a given manufacturer may produce the same wound material over and over again, using the same cores, most manufacturers are not single product/single iteration producers and they too require the use of a number of different core elements depending upon what they happen to be manufacturing that day. Finally, converters, who take the wound material and apply additionally processing steps before rewinding, as well as end users most often handle a multitude of wound materials and, hence, core elements of different sizes.

Since it is neither practical nor cost effective for manufacturers, converters and processors or end-users to stock a multitude of different diameter axels and chucks, the industry employs end caps or plugs, hereinafter, “end caps,” which fit into the ends of the different sized core element and which have a hole in the center thereof which hole is typically of a standard size consistent with industry sized axels and/or chucks. In use the axel passes through one end cap, the body of the core element and out the other end cap. Where chucks are employed the chuck will have a protrusion, shaft or like element (hereinafter the “chuck pin”) that is inserted into and, in part, seated in the hole of the end cap. Typically, these end caps are keyed such that a female structure on one of a) at least one of the end caps or b) the axel or at least one of the chucks engages a male element on the other so as to interlock the two. Similarly, there may be a like keying between the plugs or end caps and the core elements to which they are applied to prevent slippage in the rotation of the core element relative to the axel or chuck. In any event, whether such keying is present or not, there is an interference fit between the end caps and core elements.

All of this has worked well for the industry; however, removal of the end caps can be a time consuming task and can lead to damage to the end caps and/or the core elements. In this regard, the end caps are oftentimes removed by prying them out of the core element where efforts to insert a tool, often a screwdriver or like headed element, between the core element and end cap and twist or use a prying motion to extract the end cap damages the core element, especially those made of a cellulosic or plastic material. Others employ a pipe or like object that they insert into the hole of the endcap and then use a lever motion to rock or tilt the end cap out of the core element. This, however, can damage the hole and/or cause a deformation of the core element, especially if the core element is free of wound material, e.g., after the wound material has been removed.

Accordingly, there is a need for a simple tool, especially a hand-held tool, with which one is able to quickly and simply extract the end caps from core elements. In particular, there is a need for a simple tool that is able to extract the end caps from core elements without damaging either the end caps or the core elements.

### SUMMARY OF THE INVENTION

In accordance with the present invention there is provided a cap or plug extraction tool comprising

a) a body, preferably a cylindrical body, having a grip end and an operating end, a longitudinal axis along the length of the body and a body axis perpendicular to the longitudinal axis wherein the operating end of the body has a length and a diameter and is hollow or otherwise has a bore defining an operating chamber and a chamber side wall, the chamber side wall having A) opposing angled slots having a length and width, said angled slots being angled relative to the longitudinal axis from about 10 degrees to about 85 degrees, preferably from about 25 degrees to about 70 degrees, most preferably about 45 degrees, and each having a first slot end and a second slot end, and B) a longitudinal slot parallel to the longitudinal axis of the body and intermediate, along the circumference or perimeter of the chamber side wall, the opposing angled slots with the first slot end closest to the longitudinal slot and the second slot end furthest from the longitudinal slot, said longitudinal slot having a length along its longitudinal axis and a width, and

b) within the operating chamber a stop assembly, said stop assembly comprising i) a rod having a length, a rod axis along the length of the rod, and diameter, in the case of a cylindrical rod, or a width, in the case of the a non-cylindrical rod, said width being the major axis in the case of an elliptical rod or the greater of the non-length dimensions in the case of a non-elliptical rod, and ii) a stop element having diameter in the case of a round stop element or a length and height in the case of a non-round stop element and width, the length generally aligned with the longitudinal axis of the body and the width generally aligned with the perpendicular axis of the body, wherein the stop element is generally centered on and perpendicular to the rod axis,

wherein the length of the rod is approximately the same as the diameter of the operating chamber and is adapted to extend from within one angled slot to within the other angled slot and the diameter or width of the rod is less than the width of the angled slots, the width of the longitudinal slot is greater than the width of the stop element and the height or diameter of the stop element is such that none or substantially none of the stop element extends through the longitudinal slot and beyond the chamber side wall of the operating end of the body when the rod is at the second slot end and at least a portion of the height or diameter of the stop element extends through the longitudinal slot and past the chamber side wall of the operating end of the body when the rod is at the first slot end and the positioning and length of the longitudinal slot is such that at least a portion of the stop element is able to protrude through the longitudinal slot as the rod moves from the second slot end to the first slot end.

### DESCRIPTION OF THE DRAWINGS

FIGS. 1A, 18, 1C and ID are right side, front, left side and back views, respectively, of one embodiment of the present invention.

FIG. 2A is a right side view of a second embodiment of the present invention.

FIG. 2B is a partial cut away view of the second embodiment shown in FIG. 2A with the stop element extended.

FIG. 2C is a partial cut away view of the second embodiment shown in FIG. 2A with the stop element retracted.

FIG. 2D is frontal view of the second embodiment of FIG. 2A.

FIGS. 3A and 3B are side and elevated perspective views, respectively, of a stop element in the form of a disc.

FIG. 4A is a front view of the stop element of FIG. 3A mounted on a rod.

FIG. 4B is a cross-sectional view of the stop assembly of FIG. 4A taken along the line 4-4.

FIGS. 5A and 58B are side and elevated perspective views of a stop element in the form of a wedge.

FIG. 6A is a front view of the stop element of FIG. 5A mounted on a rod.

FIG. 6B is a cross-sectional view of the stop assembly of FIG. 5A taken along the line 6-6.

FIG. 7 is an alternate embodiment of the tool of FIG. 1a with a grip attached.

FIG. 8 is a cross-sectional view of the tool of FIG. 7 taken along the line 7-7.

FIG. 9 is an alternate embodiment of the tool of FIG. 2A with a modified wedge stop element.

FIGS. 10A and 10B show side expanded elevated views, respectively, of a two-piece embodiment of the extraction tool.

FIG. 11A is a frontal view of an alternate embodiment of the tool without the stop element.

FIG. 11B is a cross-sectional view of the tool of FIG. 11 taken along line 11-11.

FIGS. 12A, 12B, 12C and 12D show the progressive step operation of the use of the tool of FIG. 1 in removing an end cap

### DETAILED DESCRIPTION

For convenience, the description and figures are presented wherein the body of the extraction tool or at least the operating end thereof is cylindrical in shape. This is consistent with the general practice of using axels and chuck pins that are likewise cylindrical and plugs or end caps whose openings to accept the axels or chuck pins are round. However, it is readily contemplated that such axels and chuck pins could have a square, rectangular, etc. cross-section for use with plugs or end caps that have a like shaped receiving opening. Those skilled in the art, having the benefit of the present specification, will readily appreciate that the extraction tool as described herein is easily modified to enable use with those plugs and end caps as well and that those embodiments are within the scope of the presently claimed invention.

As used herein, the phrase “substantially none” when used in relation to the an element or component extending beyond a given point means that the element may extend beyond that point so long as it does not extend so far as to interfere with the insertion of the extraction tool into a plug or end cap or with the removal of a plug or end cap from the extraction tool.

According to the present teaching there is provided an extraction tool for removing caps or plugs, especially caps or plugs associated and/or used with cores, spindles, spools, and the like in winding and unwinding operations, said extraction tool comprising a) a body having a grip end and an operating end wherein the operating end of the body is hollow or otherwise has a bore defining an operating chamber and a chamber side wall, the chamber side wall having A) opposing angled slots and B) a longitudinal slot intermediate the two angled slots, and b) within the operating chamber a stop assembly comprising i) a rod and ii) a stop element, the stop assembly adapted to move from one end of the angled slots to the other such that when the stop assembly is at the ends of the angled slots furthest removed from the longitudinal slot none or substantially none of the stop element extends through the longitudinal slot and past the chamber side wall and when the stop assembly is at the ends of the angled slots closest to the longitudinal slot, at least a portion of the stop element extends through the longitudinal slot and past the chamber side wall. Preferably the body is cylindrical in shape, or at least the operating end of the body is cylindrical in shape such that the chamber side walls are cylindrical side walls, as will be discussed and described in detail hereinafter. However, again, following on the preceding teaching that the instant invention is not limited to cylindrical bodies, it is to be appreciated that, e.g., a square or rectangular body could be employed wherein the angled slots are in opposing walls and the longitudinal slot in one of the two remaining side walls.

The first component of the extraction tool is the body, preferably a cylindrical body, having a longitudinal axis along the length of the body and a perpendicular axis perpendicular thereto and aligned with the diameter of the cylindrical body. Preferably, the body is an elongated cylindrical element having a grip end, where the worker or an extraction apparatus is able to securely grab onto or attach to the cylindrical body, and an operating end defined by an operating chamber in which the stop assembly is situated. The body may be made of any suitable, rigid material, e.g., plastic, wood, metal, composite material, etc. While the whole of the body may be hollow, if the body is made of a molded plastic or wood, the grip end may be solid and the operating end hollow. In this case, the operating chamber is typically made by boring out the operating end of the body. The bore may be a concentric bore along the longitudinal axis of the body, a tunnel or channel like bore where the bore linear through the sidewall of the body, the like. Owing to costs and/or weight, if the body is made of a composite material or metal, it is preferable that the whole of the body be hollow. For example, in this instance, the body is made from a piece of pipe or pipe-like stock material. Of course the hollow body can also be made by molding a suitably rigid plastic material or reinforced/filled plastic material. Suitable plastic materials will depend, in part, upon the physical properties of the polymer materials and the forces and stresses that the tool must undergo during use. Of particular importance is the strength and integrity of the cylindrical side walls in the operating end. Accordingly, the preferred material is metal.

The dimensions of the tool body are a practical matter given the task at hand. Specifically, the tool body, at least the operating end of the tool body, is properly sized to allow insertion into the plugs or end caps, especially the hole therein, and may vary depending upon whether the tool is to be used manually or in a mechanical apparatus. Generally speaking, the aspect ratio of the tool body, i.e., length to diameter, is typically from about 5:1 to about 20:1, preferably from about 8:1 to about 15:1, most preferably about 10:1. For example, a simple hand held extraction tool may have a diameter of 1 inch and a body length of 10 inches. Again, larger or smaller aspect ratios are also useful.

As noted the tool body has a grip end and an operating end. The operating end has two sections, the stem section adjacent to or extending from the grip end and an operating section at the opposite end. Generally speaking, the operating end comprises at least 50%, preferably at least 60% or more of the overall length of the tool body: of course, these percentages are based on the understanding that the stem section is part of the operating end. It is to be appreciated that the stem section can just as well be an extension of the grip end, even of a diameter consistent with the grip end, so long as it is not wider or of greater diameter than the operating end since the stem must be able to penetrate into, if not through, the hole in the plug or end cap. Whether part of the grip end or the operating end, the length of the stem section is sized so as to ensure that when the extraction tool is inserted into the plug or end cap, the operating end extends far enough into and through the plug or end cap so that the stop assembly is able to extend past the cylindrical wall of the operating chamber.

For a hand held extraction tool it is desirable for the grip end to have a rubber or plastic handle or like grip element encasing the grip end or to have a texture, especially a rough texture, or an abrasive (e.g., grip filled paint) or non-slip (e.g., curable rubbery or elastomeric coating) coating applied to the outer surface of the body at the grip end. This allows the user to have a more secure grip on the tool body. Although the foregoing discussion contemplates that the body has a constant diameter, where the hole of the plug or end cap is so large or so small such that the diameter of the operating end would be difficult or uncomfortable for one to firmly grasp, the grip end may be modified or constructed to have a lesser or greater diameter, as appropriate, than the operating end or a two-piece body may be used where a given standard diameter grip end is interchangeable with different sized operating ends: the two being fastened to one another. For example, the faces of the grip end and the operating end that meet and mate may have opposing threaded elements whereby one is threaded onto the other. Other connector/attachment elements will be readily appreciated by those skilled in the art.

Where the tool is to be used with a mechanical apparatus, the grip end may have an attachment element associated therewith or integrated therein. For example, the grip end may have a ring, snap fit element, fastener, or the like that attaches to a mechanical apparatus which then effects the insertion and extraction motion used in extracting the cap or plug.

As noted above, the operating end comprises two regions, the stem region and the operating region. The former has been described above. The latter is characterized by an operating chamber within the body of the operating end which is defined by the sidewall(s) of the operating end, specifically in the case of a cylindrical body, the cylindrical side wall and a body end. The critical features of the operating end are the presence of opposing angled slots and a longitudinal slot intermediate the two angled slots in the cylindrical side wall. The opposing angled slots are angled relative to the longitudinal axis from about 10 degrees to about 85 degrees, preferably from about 25 degrees to about 70 degrees, most preferably about 45 degrees, each having a first slot end closest to the longitudinal slot and the body end and a second slot end furthest from the longitudinal slot and the body end. The width of the slots is to be slightly greater than the diameter or width of the rod of the stop assembly and the length of the slots is sufficient such that none or substantially none of the stop element extends beyond the body wall or cylindrical side wall when the rod is at the second slot ends. Generally the length of the angled slots is at least as long as the radius of the stop element or, in the case of a non-circular stop element, the distance from the center of the rod to that end of the stop element that protrudes from the side wall when the rod is at the first stop ends. The angled slots are preferably placed as close to the body end as practical, most preferably a distance removed from the body end such that the stop element does not extend beyond the body end when the rod is at the second slot ends, most preferably when the rod is at the first stop ends. Generally, the angled slots are removed from the body end by a distance the same as or similar to the radius of the stop element.

As noted, the cylindrical side wall also has established therein a longitudinal slot parallel to the longitudinal axis of the body and intermediate, along the circumference of the cylindrical side wall, the two first slot ends of the angled slots. The longitudinal slot is wider than the width of the stop element and its length is such that the stop assembly may reciprocate between the first slot ends and the second slot ends without any interference between the stop element and the cylindrical side wall. Hence the exact length and placement of the longitudinal slot depends upon the dimensions of the stop element and the placement of the angled slots. Preferably, the longitudinal slot extends from a point above the angled slots to the body end such that the slot is open at the body end as well. Generally speaking, again depending upon the shape and dimensions of the stop element, it is sufficient if the longitudinal slot begins a distance that is equal to the radius of the stop element above the second slot ends.

The second critical element of the extraction tool is the stop assembly. The stop assembly comprises i) a rod and ii) a stop element and is adapted to move from one end of the angled slots to the other such that when the stop assembly is at the second slot ends none or substantially none of the stop element extends through the longitudinal slot and past the cylindrical side wall and when the stop assembly is at the first slot ends at least a portion of the stop element extends through the longitudinal slot and past the cylindrical side wall. The rod is preferably a cylindrical rod or pin that is sized to extend from one angled slot to the other at their furthest removed point: this generally corresponds to the diameter of the operating end of the body. Of course, the length of the pin may be greater than necessary provided that the ends of the pin do not extend too far past the side wall(s) of the operating end of the body so as to interfere with the insertion thereof into the hole in the plug or cap. Although the preferred rod is cylindrical in shape, other shapes may also be used, e.g., ones having a square, hexagonal, etc., cross-section so long as the rod slides readily along the angled slots. Additionally the rod may be formed of any suitable rigid material including wood, metal, plastic, composite, etc. Preferably the rod is a metal rod.

The second component of the stop assembly is the stop element. The stop element may be a wheel, disc, wedge or like element that has a hole for accepting the rod. The stop element may be made of a rigid or semi rigid material such as wood, plastic, rubber, metal, composite, etc. or it may be a two-piece element having a wheel hub and a rubber tire or outer element around its circumference. Where the stop element is round it will have a diameter such that when the rod is in the second slot ends none or substantially none of the stop element extends through the slot and beyond the cylindrical side wall. Most preferably, the diameter of the stop element is such that when the rod is at the midpoint of the angled slots, corresponding to the greatest distance between the two angled slots, at least a portion of the stop element still extends into the longitudinal slot and, more preferably past the cylindrical side wall. Of course, other shapes may be used for the stop element. For example, the stop element may be in the shape of a wedge, e.g, a pizza slice or wedge of cheese, or triangle, where a first edge substantially parallels the longitudinal axis of the body, a second edge substantially parallels the perpendicular axis of the body and the third edge faces the longitudinal slot. Here the rod is position at or near the corner where the first and second edges meet and the rod is preferably a cylindrical rod so that the wedge pivots somewhat so that the end of the wedge defined by the point where the first and third edges meet comes into contact with the inner surface of the cylindrical wall or the operating chamber, particularly when the second edge of the wedge has made contact with the plug or end cap during the extraction process.

Additionally, one may add or incorporate a compression spring or like biasing element into the operating chamber or the stop assembly to bias the stop assembly to the first slot end. For example, with the aforementioned wedge shaped stop element, a compression spring may be attached to the first edge to force that edge away from inner wall of the operating chamber, thereby moving or biasing the wedge stop assembly to the first slot ends. The use of a spring or like biasing element is especially useful if the weight of the stop assembly is such that when the extraction tool is held in a vertical position, grip end up, the stop assembly does not readily move to the first slot ends. It is also especially helpful and useful if the extraction tool is to be used in other than a vertical or near vertical orientation.

The extraction tool is preferably assembled by inserting the stop element into the longitudinal slot and aligning the hole therein with the angled slots and then inserting the rod through one angled slot into and through the hole in the stop element until it then reaches the opposing angled slot. Preferably, the rod is inserted sufficiently far that the stop element sits at or near, preferably at, the midpoint of the rod.

The extraction tool is simple to use in removing plugs or end caps having a central hole or bore, especially those plugs or end caps that are placed into the ends of cores, spindles, spools and like elements in winding operations. Typically these plugs or end caps will have a central hole or bore that is cylindrical in shape with a side wall: the depth of which adds strength and integrity to the plug or end cap. In use, the operating end of the extraction tool is inserted into the central hole or bore. As the operating end of the extraction tool is inserted, that portion of the stop element extending through the longitudinal slot and beyond the cylindrical side wall comes into contact with the wall of the central hole or bore of the plug or end cap. As the insertion continues, the stop element is force back into the operating chamber. This causes the rod to move in the slot from the first slot end to the second slot end. Because the force is both inward and upward, movement of the rod along the angled slot is quite easy and unimpeded. Once the operating end of the extraction tool is inserted into the central hole or bore sufficiently far that the contact between the stop element and the side wall of the central hole or bore of the plug or end cap is lost, the weight or bias of the stop assembly will move the rod from the second slot end to the first slot end whereby at least a portion of the stop element will extend through the longitudinal slot and sufficiently past the cylindrical side wall of the body so that it extends past the side wall of the central hole or bore of the plug or end cap. One then makes a motion to pull the extraction tool from the central hole or bore in which case the stop element engages the lower surface of the plug or end cap. Here, the downward force of the plug or end cap on the stop element prevents the stop assembly from riding up the angled slot which would otherwise allow the stop element to retract into the operating chamber. Instead, the continued retraction motion will cause the plug or end cap to be removed from the core, spool, spindle, etc. in which it resided.

To then remove the plug or end cap from the extraction tool, one may slip the plug or cap up the tool body and off the grip end, provided the size and dimensions of the grip end accommodate such action. Alternatively, one may turn the extraction tool upside down so that the cap moves up the stem region and the weight of the stop assembly causes the stop assembly to move from the first slot end to the second slot end, whereby the stop element is retracted into the operating chamber and then simply slide the plug or end cap off the operating end of the tool. Finally, especially if there is a biasing means associate with or acting upon the stop assembly, one may manually push the stop element into the operating chamber and then slide the plug or end cap off the operating end.

Although the foregoing discussion has been focused on a tool having a single cap end extraction capability, it is to be appreciated that the tool may be modified such that a plurality of spaced elements corresponding to the operating ends are attached to a single grip end whereby multiple plugs or end caps may be extracted simultaneously. Here it is envisioned that intermediate the grip end and the operating ends there is a structure or frame having a planar configuration with the grip end or grip element attached to one surface thereof and a plurality of operating ends or operating elements equivalent to the operating end of the single unit tool, extending from the other surface. Depending upon the number of operating elements to be attached thereto, the structure or frame may be linear (especially if there are only two or three operating ends), triangular, square, rectangular, or the like. Here the selection of the shape of the structure or frame and the location of the operating elements thereon depends upon the number of operating elements so as to balance the same. Specifically, it is desirable to ensure that the grip element and the operating elements are located so as to provide a balanced tool, i.e., one where if a string were tied to the grip and the tool held by the string, the plane of the structure or frame would be parallel to the ground. Although this multi-extraction capable tool may be used manually, it is preferably used in association with a mechanical apparatus effects the operation of the tool in the extraction process. As noted above, in this instance, the grip end will likely have a means to attach the tool to the mechanical apparatus.

Having described the extraction tool in general terms, attention is now drawn to the figures which provide greater detail and specificity of several embodiments of the extraction tool.

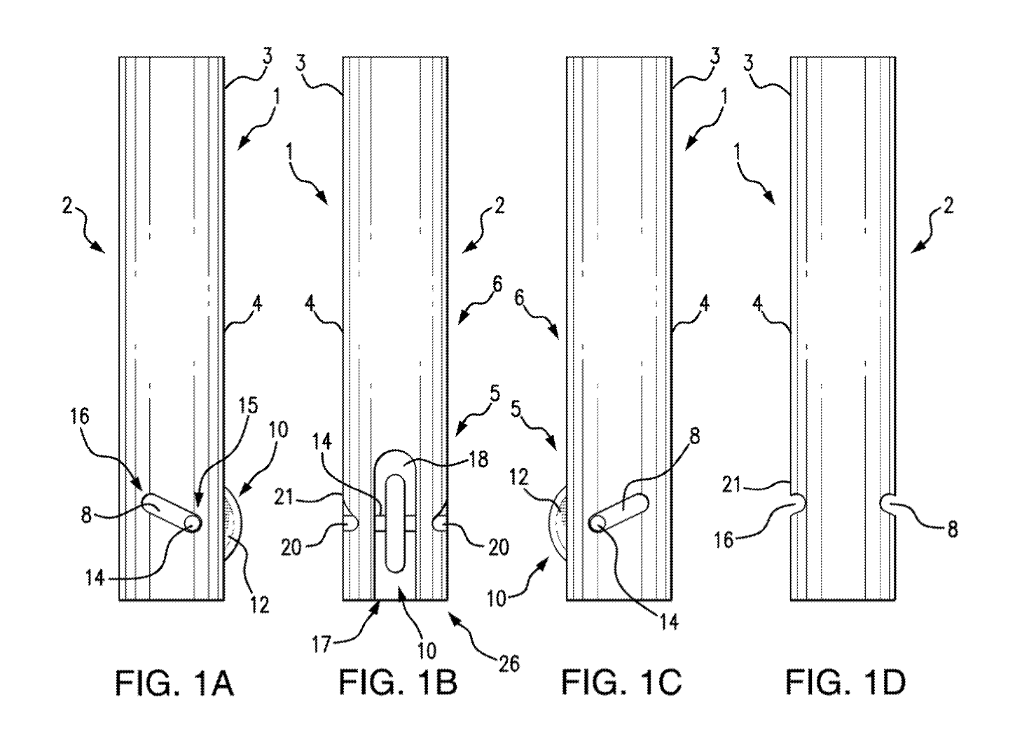

FIGS. 1A thru 1D present a 360° side view of an extraction tool 1 according to a first embodiment. The extraction tool comprises a body 2 having a grip end 3 and an operating end 4, the latter comprising an operating section 5 and a stem section 6. FIGS. 1A and 1C present opposite side views of the extraction tool showing the angled slots 8 having first slot ends 15 and second slot ends 16 and the stop assembly 10 comprising a wheel or disc stop element 12 and a rod or pin 14. FIG. 18 presents a front view of the tool showing the stop assembly 10 within the operating chamber 18 as well as the longitudinal slot 17 through which the stop element extends in use. Here the longitudinal slot is shown extending from above the angled slots to the and including the end 26 of the tool body. This view also shows the stop element 12 centered on the pin 14 with the ends 20 of the pin extending to the cylindrical side wall 21 of the body 2. FIG. 1D presents a back view of the tool where one sees the second slot ends 16 of the angled slots 8.

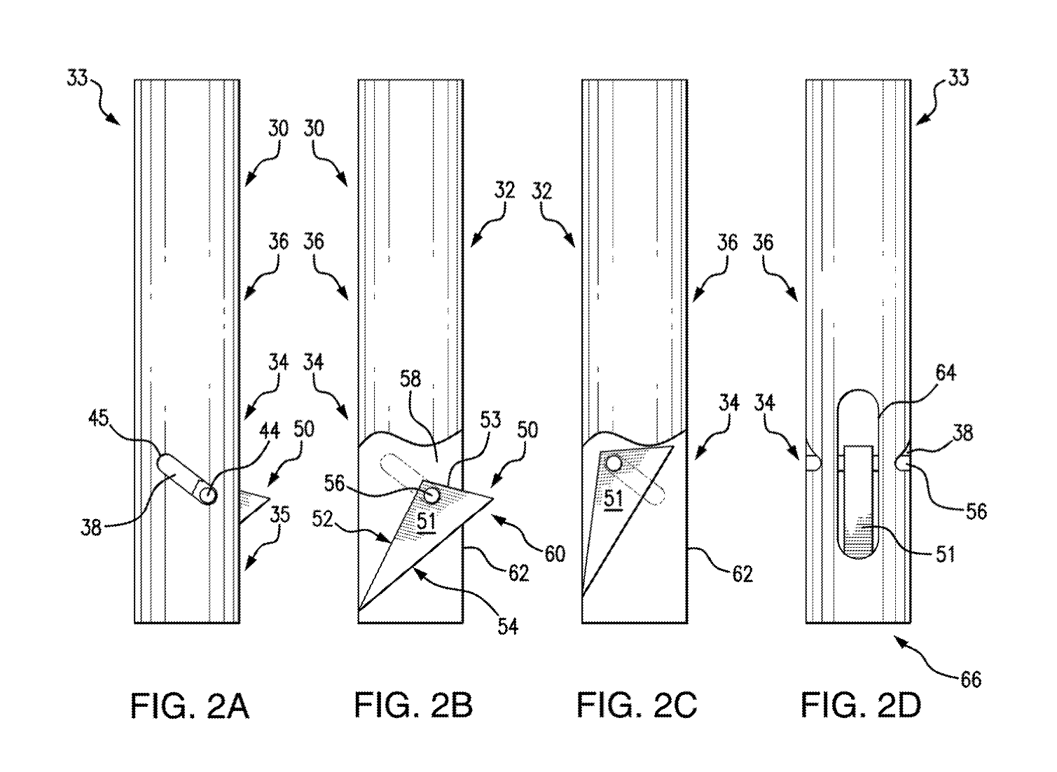

FIGS. 2A thru 2D present a 360° side view of an extraction tool 30 according to a second embodiment. The extraction tool comprises body 32 having a grip end 33 and an operating end 34 the latter comprising an operating section 35 and a stem section 36. FIG. 2A presents a side view of the extraction tool showing the angled slots 38 having a first slot end 44 and a second slot end 45 and the stop assembly 50. FIG. 2B presents the same view with a portion of the body exterior removed so as to expose the operating chamber 58 as well as the stop assembly 50 as a whole. As depicted, the stop assembly comprises a wedge stop element 51 having a first edge 52, a second edge 53 and a third edge 54 and a pin 56 which passes through a hole in the stop element and extends from one angled slot to the other. FIG. 2B shows the stop element in its extended state with the pin at the first slot ends of the angled slots and the corner of the stop element where the second and third edges meet 60 extending beyond the cylindrical side wall 62 of the operating end of the body. Conversely, FIG. 2C shows the stop element in its retracted state with the pin at the second slot ends of the angled slots and the corner of the stop element where the second and third edges meet 60 extending to or just beyond the cylindrical side wall. For convenience and clarity, FIGS. 2B and 2C show the angled slot present in that portion of the side wall that is removed in dotted lines. FIG. 2D presents a frontal view of this embodiment showing the longitudinal slot 64 extending from above the angled slots 38 to a point below the angled slots, but above the body end 66. Within the longitudinal slot one sees the third edge 54 of the stop element 51. Similarly, one sees the ends of the pin 56 in the first slot ends 44 of the angled slots.

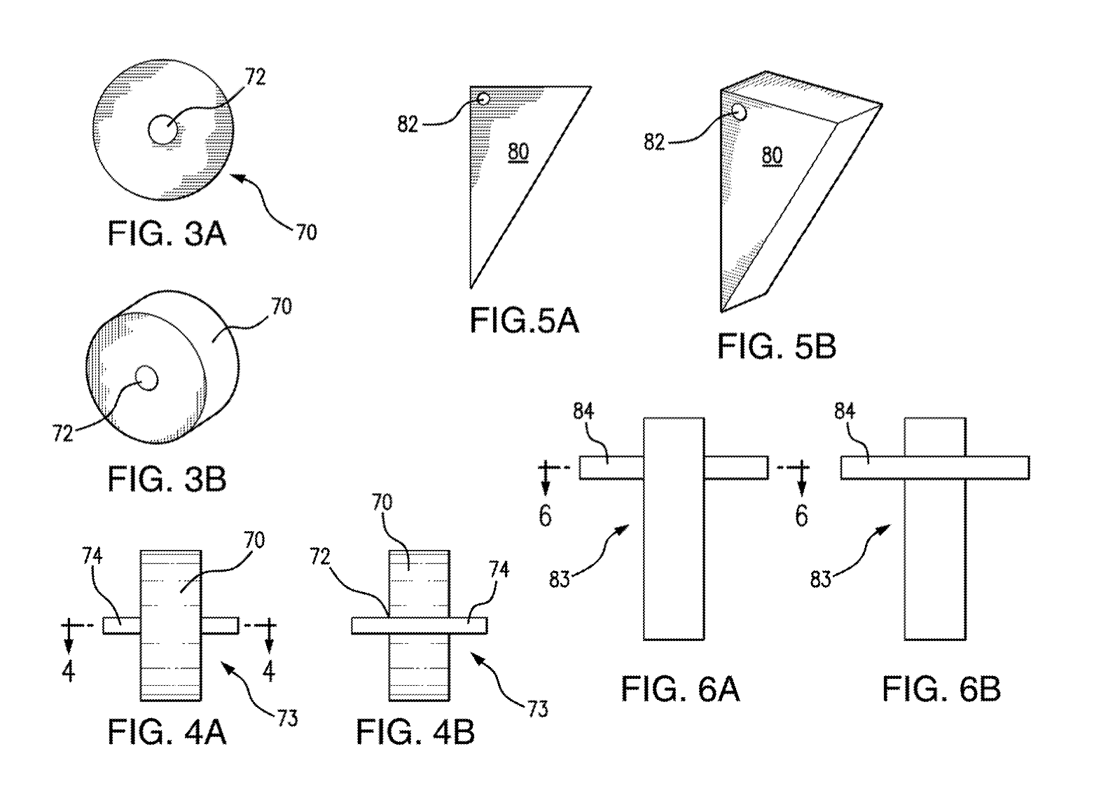

FIGS. 3A and 3B and FIGS. 4A and 4B depict a disc shaped stop element and stop assembly, respectively. FIG. 3A is a side view of a disc shaped stop element 70 having a hole 72 for accepting a pin. FIGS. 4A and 4B show the assembled stop assembly 73 comprising the disc stop element 70 and a pin 74 extending through the hole. This is more clearly seen in FIG. 4B which is a cross-sectional presentation of the assembly of FIG. 4A along the line 4-4.

FIGS. 5A and 5B and FIGS. 6A and 6B depict a wedge shaped stop element and stop assembly, respectively. FIG. 5A is a side view of a wedge shaped stop element 80 having a hole 82 for accepting a pin. FIGS. 6A and 6B show the assembled stop assembly 83 comprising the wedge shaped stop element 80 and a pin 84 extending through the hole. This is more clearly seen in FIG. 6B which is a cross-sectional presentation of the assembly of FIG. 6A along the line 6-6.

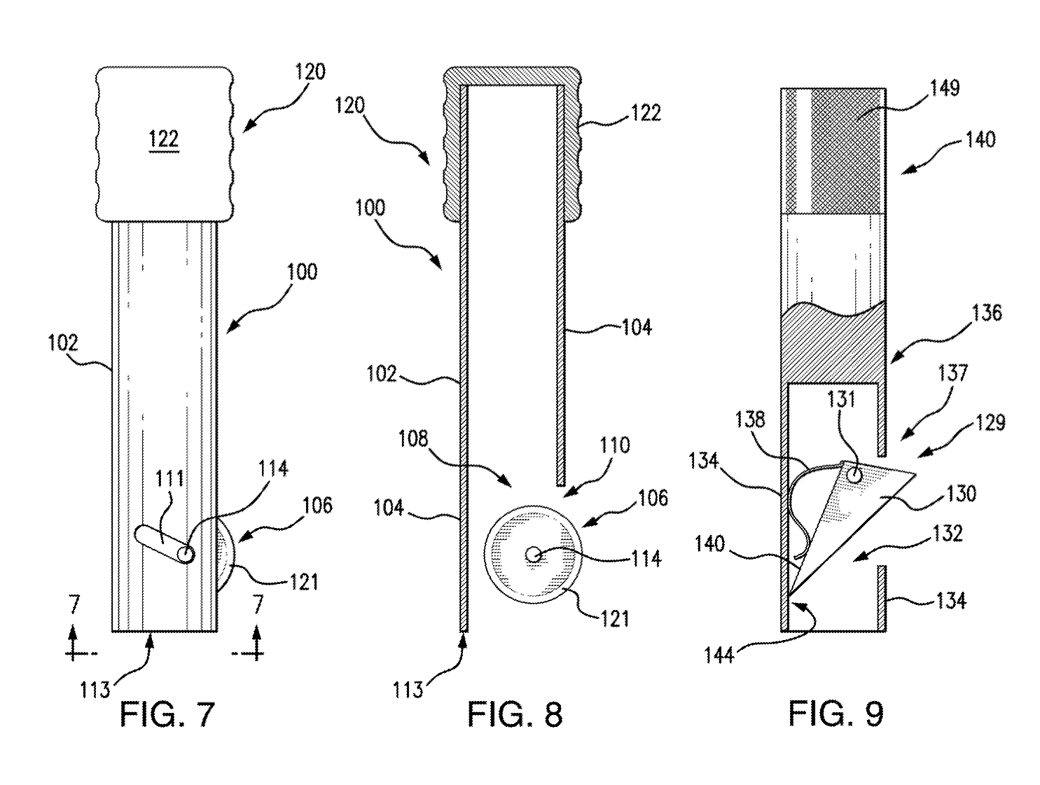

FIGS. 7 and 8 present a side view and a cross-sectional view of a third embodiment of the present invention. FIG. 8 is a cross-sectional view taken along the line 7-7 of FIG. 7. As depicted, the extraction tool 100 has a body 102 which is hollow and is defined by cylindrical side wall 104. This embodiment employs a disc stop assembly 106 in the operating chamber 108. The stop assembly comprises a disc stop element 121 and a pin 114 which, in the state presented, extends through the longitudinal slot 110 which extend from above the angled slots 111 to the end of the body 113. The grip end 120 of the body 102 has a grip element 122 overlaying the grip end, with the grip end inserted into a bore or cylindrical recess in the grip element.

FIG. 9 presents a partial cross-sectional view of yet another embodiment, similar to that of FIGS. 2A thru 2D, with a stop assembly 129 having a wedge shaped stop element 130 and pin 131 within the operating chamber 132 defined by the cylindrical side wall 134. In this embodiment, the wedge shaped element has a compression spring or element 138 along is first edge 140 which compression spring biases the stop assembly to its extended position with the corner of the wedge defined by its second and third edges extending through the longitudinal slot 137 and past the cylindrical side wall 134. As the stop assembly moves from the extended position to the retracted position, the compression spring compresses, and the pin moves along the angled slots (not shown) while the wedge stop element/stop assembly pivots about the pin with the corner of the wedge stop element defined by the first and third edges, sits against the inner surface 144 of the cylindrical sidewall 134. Additionally, in this embodiment, the stem section 136 as well as the grip end 140 are solid and the grip end has a textured surface or an abrasive coating or non-slip coating 148 applied to the surface thereof.

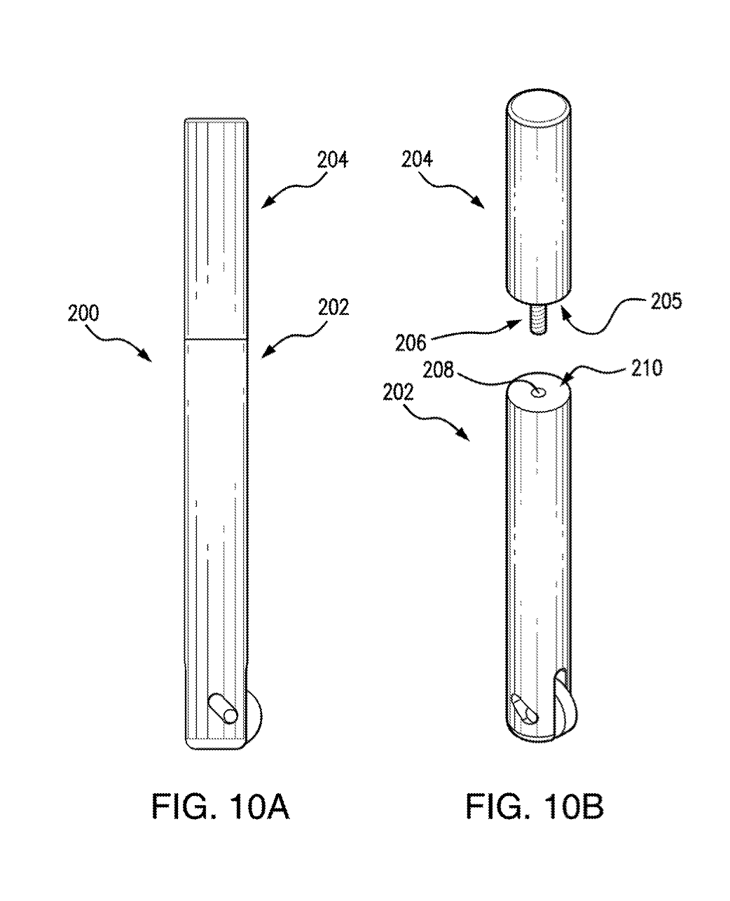

FIGS. 10A and 10B depict a two-piece extraction tool 200 having a separate operating end 202 and a separate grip end 204 wherein the lower end surface 205 of the grip end has a male threaded element 206 which threadingly engages a female threaded bore 208 in the upper end surface 210 of the operating end. FIG. 10 a shows the assembled extraction tool while FIG. 10B presents an elevated view of the unassembled extraction tool. The remaining elements of this embodiment are as presented in FIG. 1A. Of course other fastener means may be employed and the elements of each may be switched from one of the operating end or the grip end to the other. For example, instead of the orientation as shown in FIGS. 10A and 10B, the male threaded element could be on the operating end and the female threaded element on the grip end. This ability to make a modular extraction tool allows one to switch out the operating ends to accommodate different plugs and end caps. For example, the hole in the plug or end caps may have a different shape, a different diameter, a longer side wall, etc. which may necessitate a different configuration of the operating end. Additionally, by this method one is able to maintain a given grip size, regardless of the size of the operating end. Likewise, one can switch the grip ends if one desires to switch between manual operation and extraction using a mechanical apparatus, e.g., automated extraction.

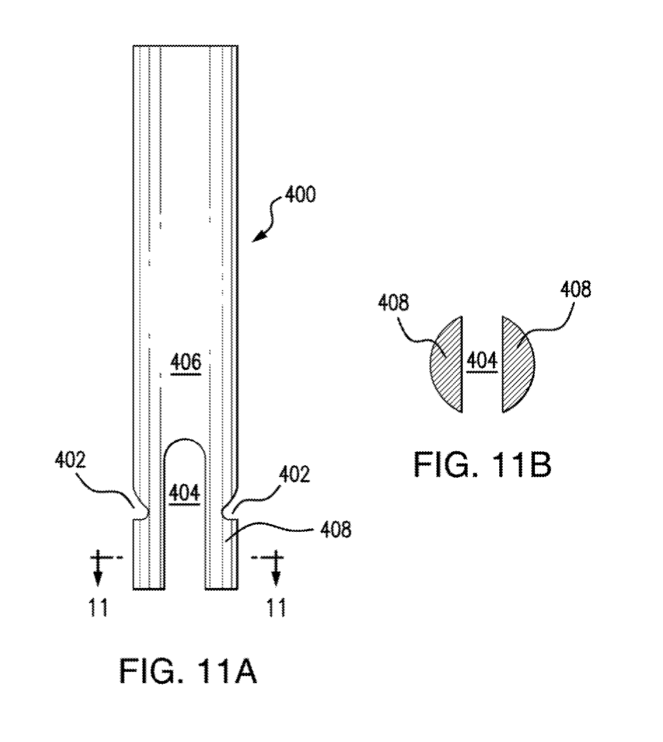

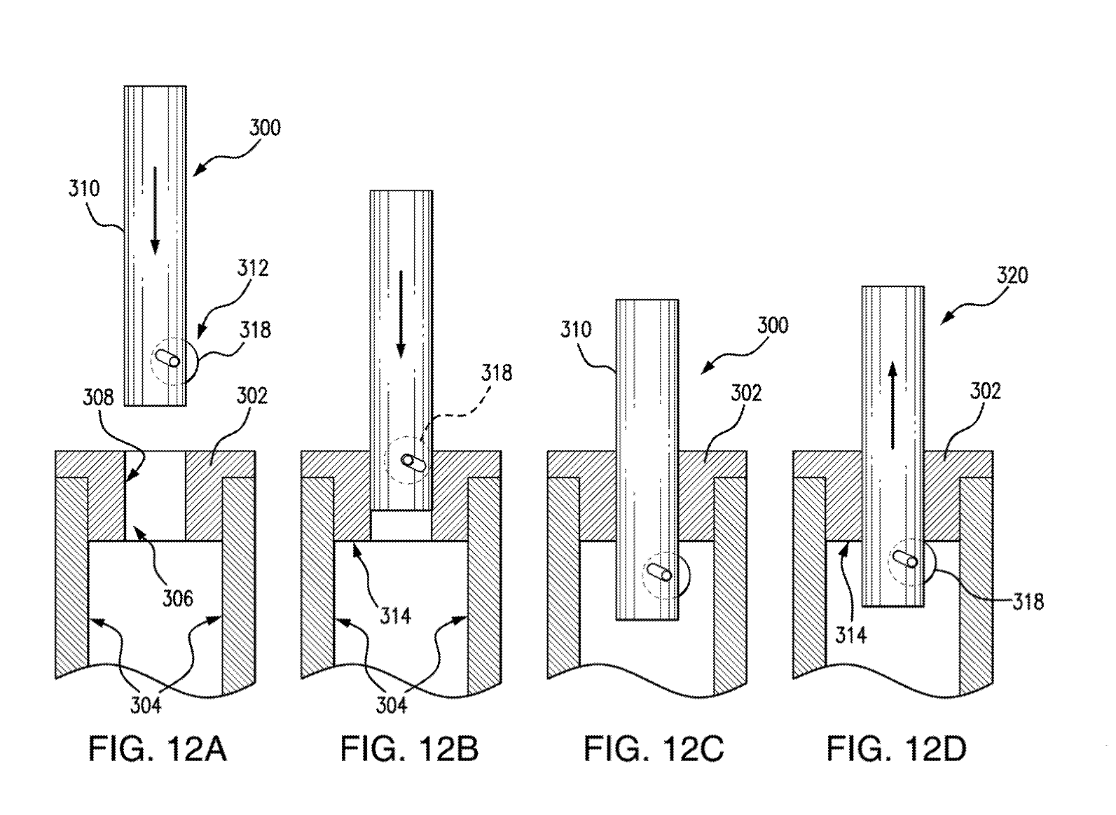

Finally, FIGS. 12A and 12B present yet another embodiment of the extraction tool 400. Whereas the embodiment shown in the earlier figures has a concentric bore or hollow operating chamber, the operating chamber of this embodiment is a linear or tunnel bore 404 through the sidewall of the the operating end 406 along the body axis. FIG. 12A presents a face on view of the extraction tool 400 whereas FIG. 12B presents the cross-sectional view along the line 11-11 of FIG. 11A. With this embodiment the sidewalls 408 of the operating chamber are thicker and stronger than with the sidewalls associated with the concentric bore as shown in, for example, FIG. 9. This could be important depending upon the forces needed to extract the plugs or end caps from the core elements.

Having described various embodiments and features of the extraction tool, attention is now drawn to FIGS. 12A through 12D which depict the sequence of use of the extraction tool 300 in extracting an end cap 302 from a core 304. As depicted in FIG. 12A, the longitudinal body 310 of the extraction tool 300 is aligned with the hole or bore 306 in the plug or end cap. The operating end 312 of the extraction tool is then inserted into the bore or hole 306. As shown in FIG. 12B, as the insertion continues the stop element 318 makes contact with the wall 308 of the bore or hole causing the stop element, hence the stop assembly, to retract into the operating chamber, as described above. The insertion continues until the stop element is past the end 314 of the end cap 302 as shown in FIG. 12C. At this point, gravity or the biasing element, if present, moves the stop assembly back to its original position with the stop element extending through the longitudinal slot and past the side wall of the operating chamber. Finally, the motion of the extraction tool is reversed so as to begin to extract the extraction tool from the bore or hole in the cap. However, as shown in FIG. 12D, the stop element 318 makes contact with the end 314 of the end cap 302. Because the slope of the angled slot is upward, towards the end cap, the force of the end cap on the stop element prevents the retraction of the stop assembly. Continued pulling of the extraction tool results in the extraction tool and end cap being removed or extracted from the end of the core 304. The end cap can then be removed by sliding the end cap up and off the grip end 320 of the extraction tool or by turning the extraction tool upside down so that the stop assembly retracts into the operating chamber and then sliding the end cap off the operating end of the extraction tool.

While the method and apparatus of the present specification have been described with respect to specific embodiments and figures, it should be appreciated that the present teachings are not limited thereto and other embodiments utilizing the concepts expressed herein are intended and contemplated without departing from the scope of the present teaching. Thus, the true scope of the present teachings is defined by the claimed elements and any and all modifications, variations, or equivalents that fall within the spirit and scope of the underlying principles set forth herein.

I claim:

1. A tool comprising
a) a body having a grip end and an operating end, a longitudinal axis along the length of the body and a body axis perpendicular to the longitudinal axis wherein the operating end of the body has a length and a diameter and is hollow or otherwise has a bore defining an operating chamber and a chamber side wall, the chamber side wall having A) opposing angled slots having a length and width, said angled slots being angled relative to the longitudinal axis from about 10 degrees to about 85 degrees and each having a first slot end and a second slot end, and B) a longitudinal slot parallel to the longitudinal axis of the body and intermediate, along the circumference or perimeter of the chamber side wall, the opposing angled slots with the first slot end closest to the longitudinal slot and the second slot end furthest from the longitudinal slot, said longitudinal slot having a length along its longitudinal axis and a width, and
b) within the operating chamber a stop assembly, said stop assembly comprising i) a rod having a length, a rod axis along the length of the rod, and diameter, in the case of a cylindrical rod, or a width, in the case of the a non-cylindrical rod, said width being the major axis in the case of an elliptical rod or the greater of the non-length dimensions in the case of a non-elliptical rod, and ii) a stop element having diameter in the case of a round stop element or a length and height in the case of a non-round stop element and width, the length generally aligned with the longitudinal axis of the body and the width generally aligned with the perpendicular axis of the body, wherein the stop element is generally centered on and perpendicular to the rod axis,
wherein the length of the rod is approximately the same as the diameter of the operating chamber and is adapted to extend from within one angled slot to within the other angled slot and the diameter or width of the rod is less than the width of the angled slots, the width of the longitudinal slot is greater than the width of the stop element and the height or diameter of the stop element is such that none or substantially none of the stop element extends through the longitudinal slot and beyond the chamber side wall of the operating end of the body when the rod is at the second slot end and at least a portion of the height or diameter of the stop element extends through the longitudinal slot and past the chamber side wall of the operating end of the body when the rod is at the first slot end and the positioning and length of the longitudinal slot is such that at least a portion of the stop element is able to protrude through the longitudinal slot as the rod moves from the second slot end to the first slot end.

2. The tool of claim 1 wherein the body is a cylindrical.

3. The tool of claim 1 wherein the operating end of the body is cylindrical,

4. The tool of claim 1 wherein the angle of the slots to the longitudinal axis of the body is from about 25 degrees to about 70 degrees.

5. The tool of claim 1 wherein the angle of the slots to the longitudinal axis of the body is about 45 degrees.

6. The tool of claim 1 wherein the operating chamber is a cylindrical bore in the operating end.

7. The tool of claim 6 wherein only a single longitudinal slot is present in the chamber side wall.

8. The tool of claim 1 wherein there are two opposing longitudinal slots in the chamber side wall.

9. The tool of claim 1 wherein the operating chamber is a linear or tunnel-like bore along the body axis.

10. The tool of claim 9 wherein there are two longitudinal slots corresponding to each end of the linear or tunnel-like bore.

11. The tool of claim 1 wherein the body is a two-piece body one piece comprising the grip end and the other piece comprising the operating end.

12. The tool of claim 11 wherein the body is adapted to interchange different operating bodies on the grip end.

14. The tool of claim 1 wherein the aspect ratio of the tool body is from about 5:1 to about 20:1.

14. The tool of claim 1 wherein the grip end has a rubber or plastic handle or grip element encasing at least part of the grip end.

15. The tool of claim 1 wherein the grip end has a textured surface or an abrasive coating on at least part of the grip end.

16. The tool of claim 1 wherein the operating end comprises the operating chamber and a stem portion intermediate the operating chamber and the grip end.

17. The tool of claim 16 wherein the length of the stem portion is adapted to allow the operating chamber to pass completely through the hole in a plug or end cap when the operating end of the body is inserted therein.

18. The tool of claim 16 wherein the operating end comprises at least 50% of the tool body.

19. The tool of claim 1 wherein the stop element is a wheel and the rod is an axel.

20. The tool of claim 1 wherein the body is made of metal.
